(19) United States
(12) Patent Application Publication
(10) Pub. No.: US 2006/0148627 A1
(43) Pub. Date: Jul. 6, 2006

(54) Insertion-type packaging method and packaging set for plate-shaped materials

(76) Inventors: Sven Freyer, Uslar (DE); Erich Sander, Osterode (DE); Stefan Niessen, Osterode (DE); Bernhard Sudhoff, Bad Lauterberg (DE)

Correspondence Address: PATENT LEGAL STAFF, EASTMAN KODAK COMPANY, 343 STATE STREET, ROCHESTER, NY, 14650-2201, US

(21) Appl. No.: 10/543,978

(22) PCT Filed: Jan. 22, 2004
(86) PCT No.: PCT/EP04/00524

§ 371 Date: Jul. 29, 2005

(30) Foreign Application Priority Data
Jan. 31, 2003 (DE) 10303905.8
Apr. 15, 2003 (DE) 10317324.2

(51) Int. Cl. B31B 1/00

(52) U.S. Cl. 493/51

(57) ABSTRACT

The present invention provides for a packaging method and a packaging structure or a packaging set, particularly for plate-shaped goods. In particular, the present invention relates to a packaging method and a packaging set, and especially a plug-in connection type packaging set, which can specifically be arranged around plate shaped goods of different sizes while acting as a shock absorber, spacer, anti-skid device and static stabilising device. The packaging structure is further provided with a base plate and a cover of a transport container that is designed so a to match the unconventional inner packaging set while fitting on conventional pallets.

The present invention relates to a packaging method and a packaging structure or a packaging set, particularly for plate-shaped goods. In particular, the present invention relates to a packaging method and a packaging set, and especially a plug-in connection-type packaging set which can specifically be arranged around plate-shaped goods of different sizes while acting as a shock absorber, spacer, anti-skid device and static stabilising device. The packaging structure is further provided with a base plate and a cover of a transport container that is designed so as to match the unconventional inner packaging set while fitting on conventional pallets.

In view of the steadily rising costs for waste disposal, an increased environmental awareness among producers and customers and the time-consuming and expensive method of securing goods in a container by using filling or padding materials, it has become a necessity to think over new packaging methods, which has been done in all political and economical forums in Europe.

Conventional container packaging for sensitive plate-shaped goods, such as offset printing plates, involves two major problems:

The first problem consists in the varying plate sizes. Up to 200 standard sizes have to be accommodated in respective containers, which constitutes a logistic problem for purchasing, stocking and storing, and selection. Furthermore, shocks and friction caused by shifting within the container may damage the plates, thus rendering them useless to customers.

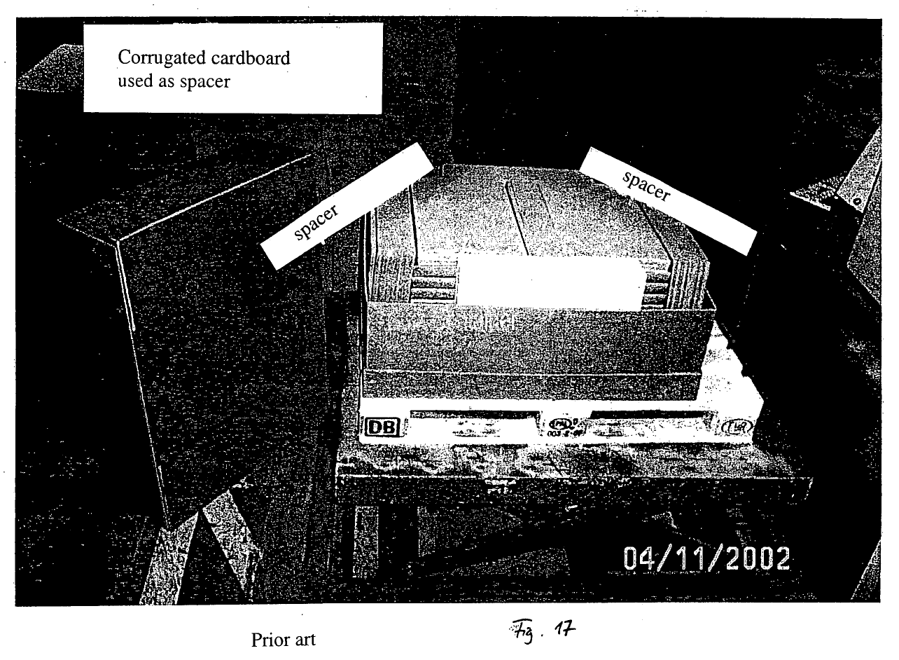

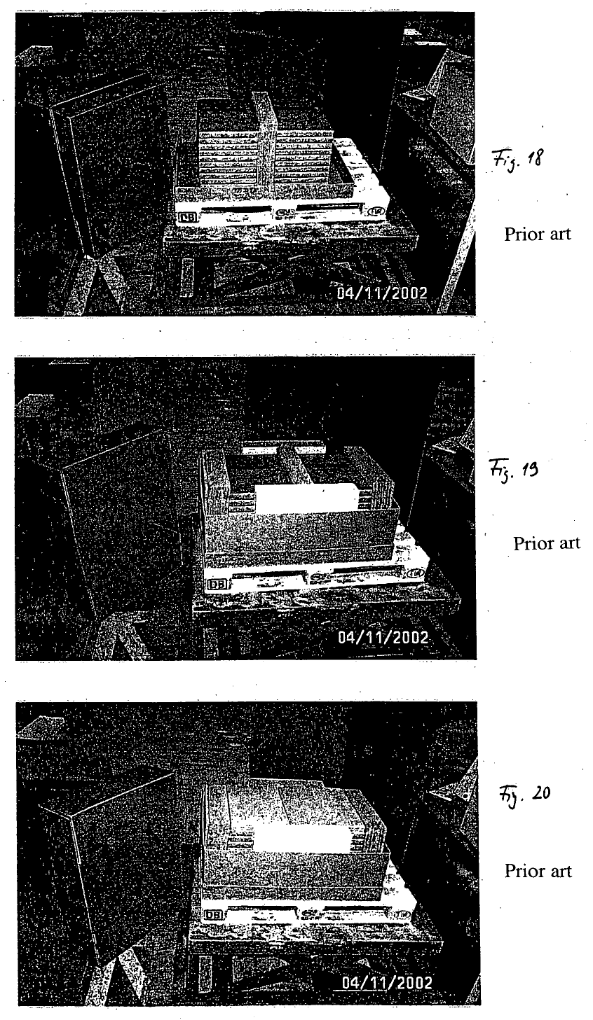

In order to reduce the danger of damage during transport, an expensive and time-consuming spacing and padding method was developed, which is shown in FIGS. 17 to 20. A conventional container consists of a fibre board bottom with a low rim open at one side to make machine plate stacking possible. Upon placing the plates on the container bottom, the rim has to be upended and fixed. This step and all further steps of the packaging process have to be accomplished manually due to the different container sizes. Then, a suitable cardboard ring is fitted to the container rim as a heightening frame to enable the application of padding material and stabilise the container statically. The space formed between the plate stack and the frame is filled with a soft cardboard material. Up to ten centimetres of space have to be padded with this material to protect the plates reliably against shocks and shifting. Often, the amount of filling material required is one ton per day. Moreover, a soft cardboard material having a suitable size has to be put on top of the plate stack to act as spacing and insulating material against the container cover. This is furthermore disadvantageous in that, particularly when large-sized containers are involved, the softness of the material provides a shock-absorbing effect but does not stabilise the container cover statically, thus making it impossible to stack containers on top of each other or to pile other heavy goods on top of the covers.

Apart from the procurement costs, the time-consuming and labour-intensive method and the difficulties during transport and storage, the large amount of filling material required of course involves many other negative effects, such as an environmental and ecological incompatibility and problems with waste disposal and waste incineration, both for producers and the customers.

U.S. Pat. No. 4,795,083 describes a slotted partition apparatus for packaging. In particular, U.S. Pat. No. 4,795,083 describes an assembled slotted partition apparatus for repeated use within three-dimensional packaging containers towards describing containment and cushioning regions therewithin. The apparatus is constructed so as to preclude against its own inadvertent disassembly between and during repeated uses, and relies upon the utilisation of primary and secondary interlocking panel members operably receiving one another through the utilisation of aligned slots. Primary and secondary spacer locking elements align with each other upon assembly of the primary and secondary panels to describe a partition apparatus in which all structural portions remain intact for reuse in further shipping operations, without any reassembly and/or reattachment of the primary and/or secondary panels to one another.

Since plate-shaped goods, such as offset printing plates, are extremely sensitive to the influence of light and temperature fluctuations and, moreover, shocks and friction have to be prevented, a variety of new packaging methods have been developed, tried and used within the last few years, the focus of interest being almost exclusively on the problem of light-proof packaging. The resulting series of quite specific and consequently often very expensive inner packaging sets did solve the problem of light and temperature sensitivity in a satisfactory manner; however, conventional containers having the aforementioned disadvantages were still used as outer packaging sets. In this context, reference is made to EP-A-1 081 550, EP-A-1 184 718, EP-A-1 207 122, EP-A-1 138 520, EP-A-0 744 344, EP-A-0 718 683, EP-A-0 292 007, EP-A-0 955 564, U.S. 2001/0032797 and DE-A-195 26 335.

The present invention provides an improved packaging set and an improved packaging method.

The present invention provides a packaging structure comprising at least four partitions forming a frame if assembled which frame partitions a rectangular reception area of variable size for the plate-shaped goods to be packaged. Each partition comprises two opposing edges and at least two partition slots that extend substantially perpendicular to said edges. The at least two partition slots of the first. and fourth partitions are arranged along one of said two opposing edges and extend substantially perpendicular to said one edge while the at least two partition slots of the second and third partitions are arranged along the two opposing edges such that the partition slots are arranged along one edge diagonally opposite the partition slots along the other edge and extend perpendicular to said edges.

According to the packaging method of the present invention, first, a partition slot provided in an edge of the second partition is inserted into a partition slot provided in the edge of the first partition wall. Then, a partition slot provided in an edge of the third partition is inserted into a partition slot provided in the other edge of the second partition. A partition slot provided in the edge of the fourth partition is subsequently inserted into a partition slot provided in the other edge of the third partition while a further partition slot provided in the edge of the fourth partition is inserted into a further partition slot provided in the edge of the first partition. In other words, the partitions are interconnected circumferentially clockwise or anticlockwise.

The components of the packaging structure according to the present invention have standardised shapes although the plates to be packaged and dispatched have a variety of different formats or sizes. As a further advantage, according to the present invention, the amount of filling material may be reduced to a minimum as compared to all known packaging methods without the danger of damage to the plate-shaped goods to be packaged being increased. Moreover, the present invention considerably eases the work of both the packaging crew and the customers unpacking the goods. Moreover, manual work during the packaging process is minimised, which complies with the general attempts to save costs by automation. During the packaging process, only one person has to execute five short consecutive steps.

The plates may be stacked as required depending on the selected pallet. There is no need to select a suitably sized container since the inside of the packaging set is adapted to the format of the plates. The present packaging structure does not have to consist of any specific material. As long as the material exhibits sufficient strength and stiffness, it may be selected depending on availability and market prices. Moreover, the packaging structure may both be recycled and reused for different products because it remains undamaged when being unpacked.

The present invention provides for an outer packaging set and a method for industrial use, which set is multifunctional, of variable size, easy to handle, time- and cost-saving and, if possible, made of recyclable material so as to protect natural resources.

The present invention will be illustrated in the following with reference to the drawings, in which:

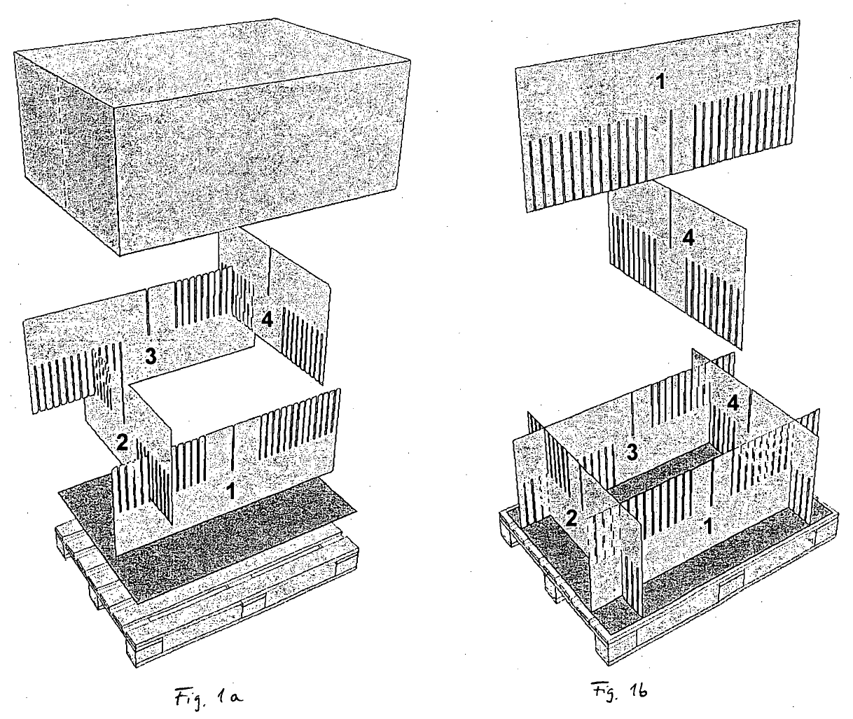

FIGS. 1a and b show the packaging set according to the invention, wherein FIG. 1a illustrates the arrangement of the components of the packaging set during the assembly and FIG. 1b shows a frame consisting of four plus two additional interleaving partitions;

FIG. 2 shows the arrangement, size and fixation of the base plate on the pallet;

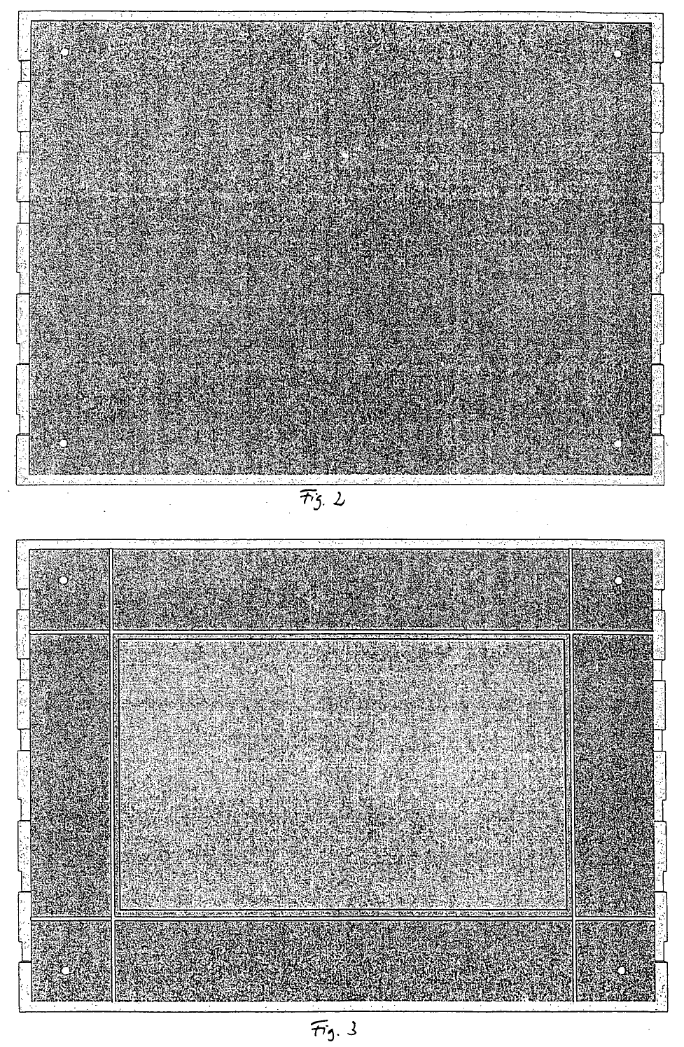

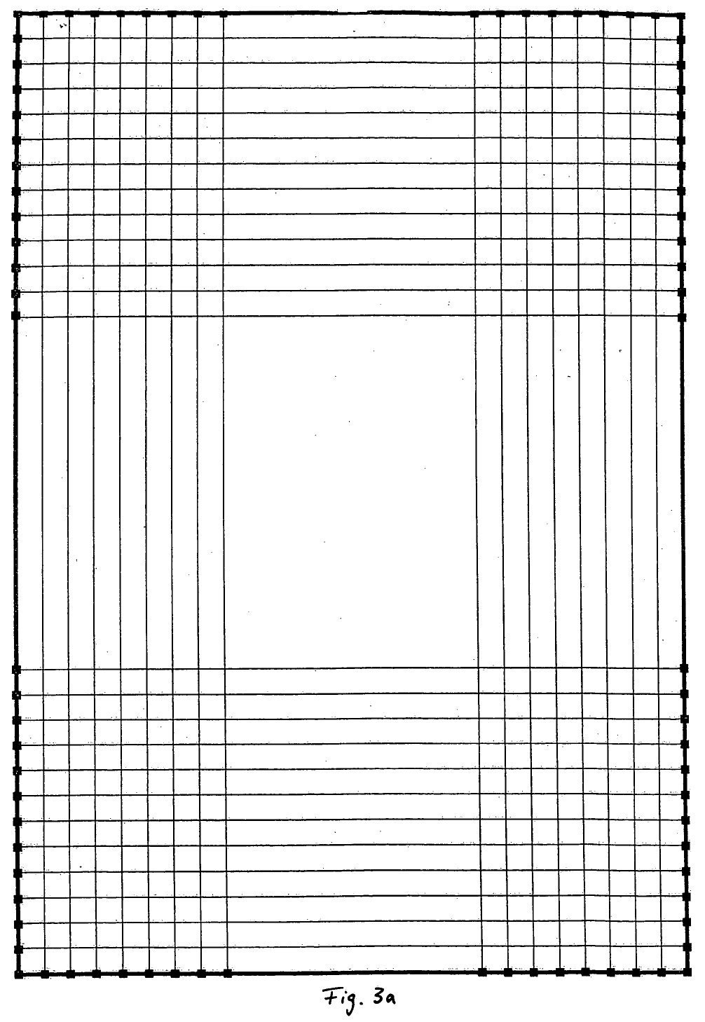

FIG. 3 shows the base plate on the pallet with the frame consisting of four partitions thereon, wherein the inner rectangle formed by the partitions forms the reception area for the plate-shaped goods to be packaged;

FIG. 3a shows a variety of possible sizes of the rectangular reception area that is formed by the four partitions of the packaging set according to the invention;

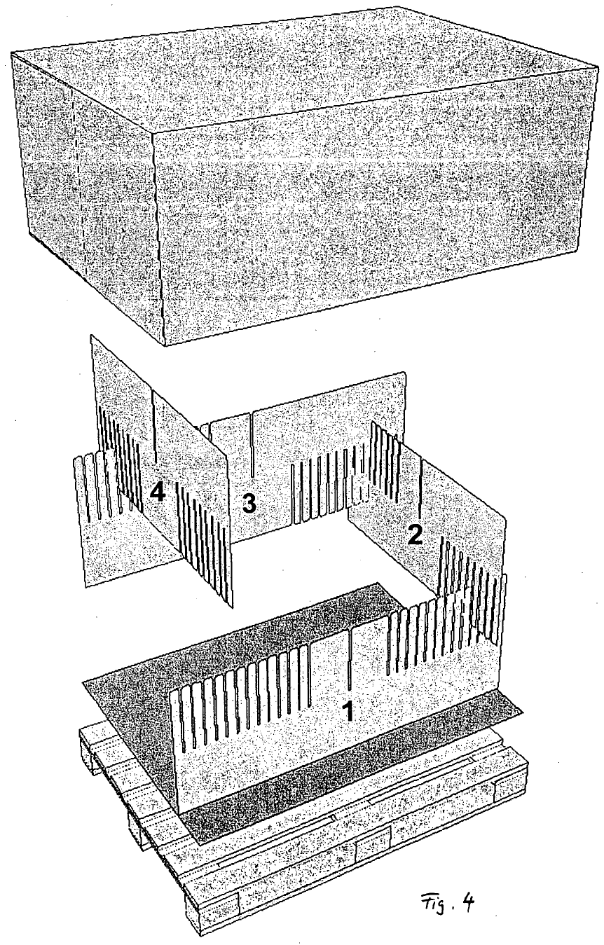

FIGS. 4, 5 and 6 show variations in the assembly of the four (or six) partitions according to the present invention. FIGS. 4 and 5 constitute a laterally reversed view of FIGS. 1a and 1b. In FIG. 6, the two additional partitions are set up to further partition the reception area in front of the four partitions forming the rectangular reception area;

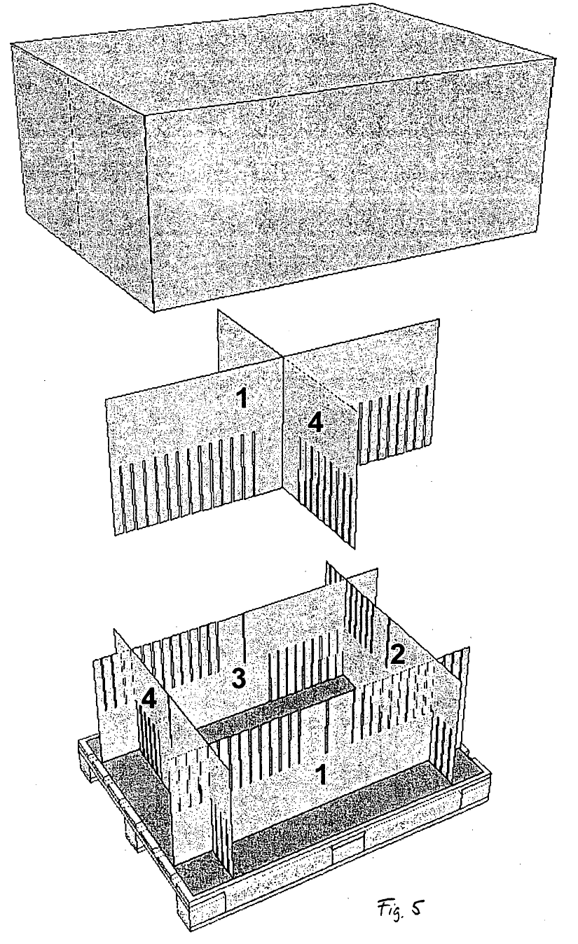

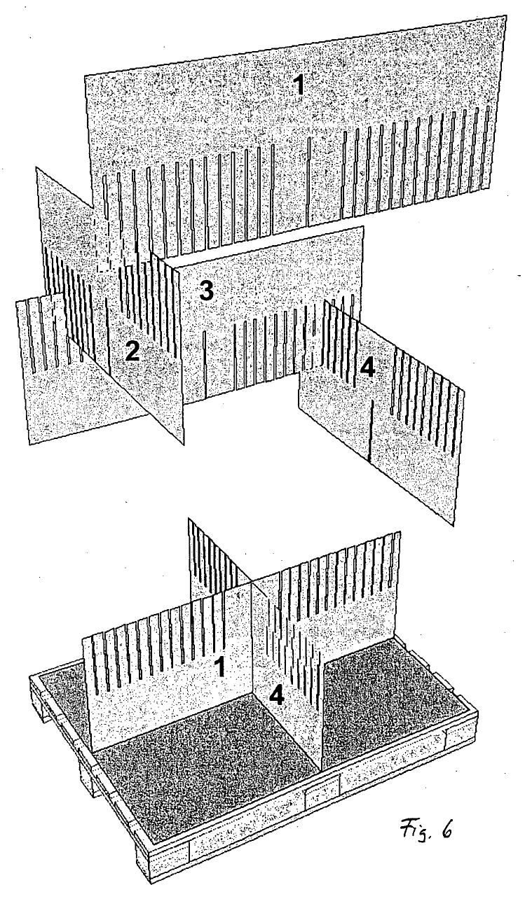

FIGS. 7 to 9 show different possibilities of further partitioning the rectangular reception area;

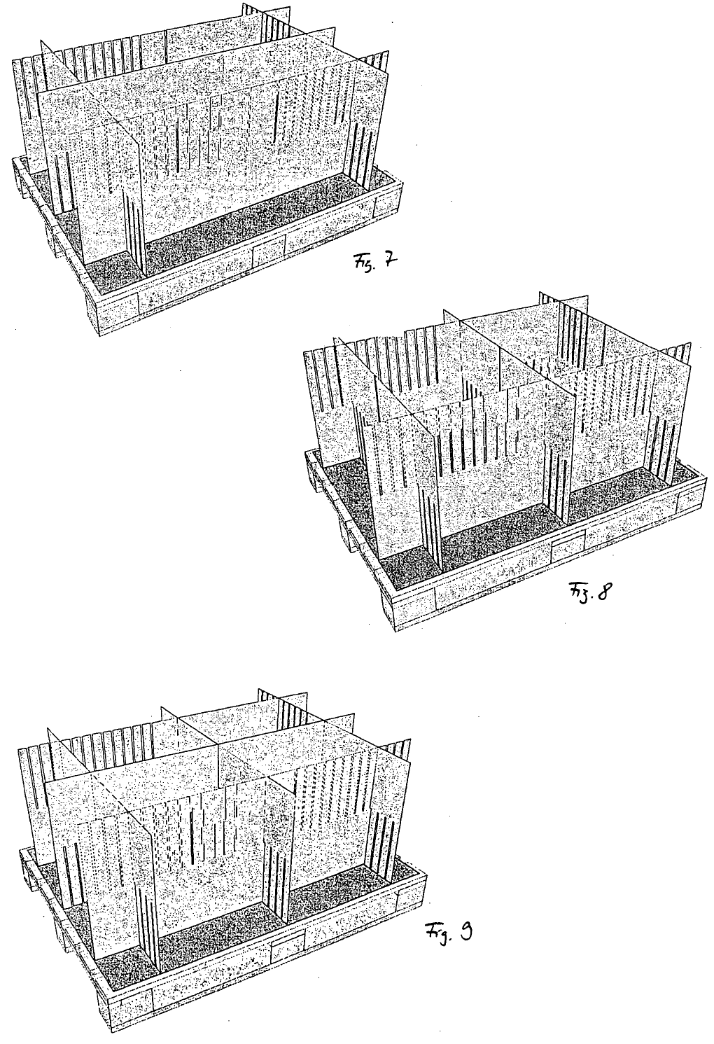

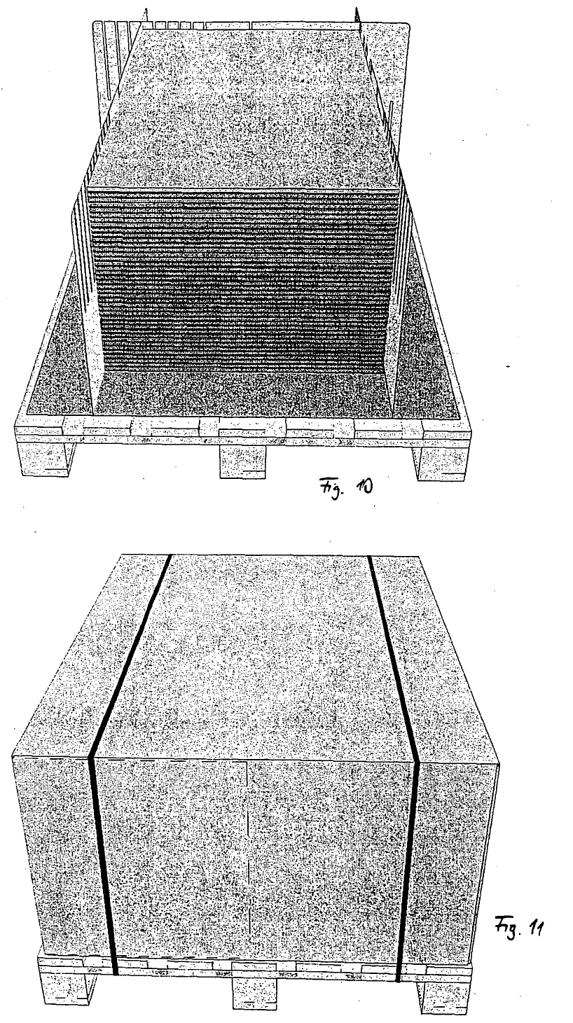

FIGS. 10 to 12 show a stack of plate-shaped goods, wherein in FIG. 10 three partitions are arranged at three sides of the stack, in FIG. 11 the cover is fixed to the pallet and in FIG. 12 a phantom view through the cover illustrates the static stabilisation by the frame formed by four partitions;

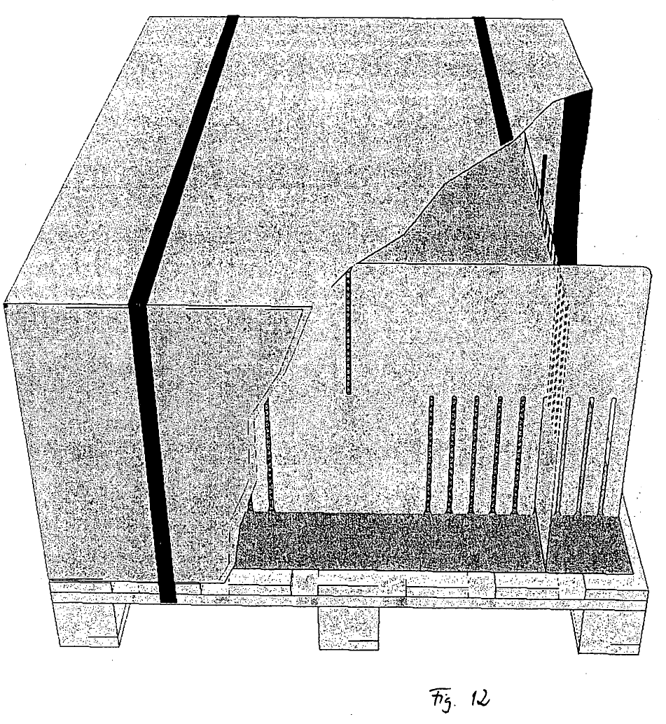

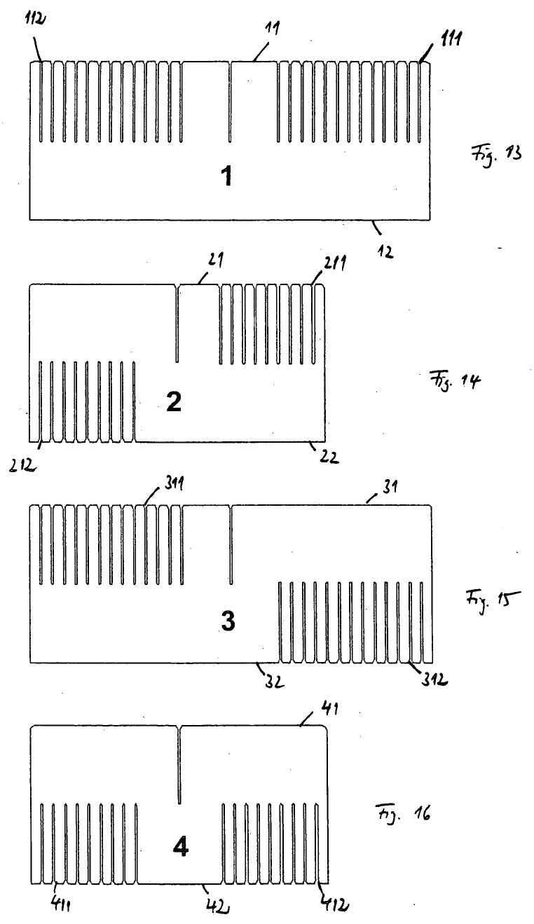

FIGS. 13 to 16 show the four partitions in a preferred embodiment of the present invention, wherein the partitions 1 and 3 comprise 2×13 partition slots and the partitions 2 and 4 comprise 2×9 partition slots and all partitions are moreover provided with a central partition slot enabling a further partitioning of the reception area;

FIG. 17 show a conventional packaging set, wherein the space between the plate-shaped goods and the container is filled with cardboard; and

FIGS. 18 to 20 show three steps of the conventional packaging method.

In a preferred embodiment, the packaging set according to the present invention, as shown for example in FIGS. 1 to 3, comprises the following components: A base plate arranged on a pallet, a slotted longitudinal partition 1, a slotted transversal partition 2, a slotted longitudinal partition 3, a slotted longitudinal partition 4 and a cover. If the reception area formed by the four partitions 1 to 4 is to be partitioned, a further longitudinal partition 1 and/or a further transversal partition 4 is required. The arrangement of the additional partitions 1 and/or 4 is shown in FIGS. 7 to 9. Preferably, the base plate, the partitions and the cover are made of triple corrugated cardboard.

All components of the packaging set are designed so as to be interconnectable. The partitions preferably have a rectangular shape and all partitions that are parallel with respect to the slots have the same side length. The longitudinal partitions 1 and 3 and the transversal partitions 2 and 4 each have the same side length perpendicular to the slots. The exact dimensions of the partitions and the base plate and the cover are determined by the size of the pallet used.

The base plate is preferably fixed to the pallet by four screws to prevent the bottom plate from sliding. The size of the bottom plate is selected such that the pallet projects over the rim of the base plate so that the edge of the cover rests on the pallet and the cover is held in a fixed position by the bottom plate and prevented from shifting. Preferably, the edge of the cover should be flush with the edges of the pallet. The partitions are fitted into each other on the bottom plate. The side lengths of the partitions in the direction perpendicular to the slots are adapted to the size of the bottom plate. The partitions form a rectangular inner area that serves as reception area for the plate-shaped goods to be packaged. The arrangement of the plate-shaped goods is shown in FIGS. 3 to 10.

FIGS. 13 to 16 show a preferred embodiment of partitions 1 to 4. In this embodiment, the partitions have a multitude of partition slots 111, 112, 211, 212, 311, 312, 411, 412 along the respective edges 11, 21, 22, 31, 32, 42. Thus, the size of the formed reception area is variable by the selection of the slots that are used for fitting the partitions into each other. In particular, each of the partitions shown in the Figures is provided with two groups having the same number of partition slots which are spaced apart from each other by the same distance. In the example shown, each of the longitudinal partitions 1 and 3 is provided with 2×13 slots and each of the transversal slots 2 and 4 is provided with 2×9 slots. The position of the partition slots relative to the edges parallel to the direction in which the slots extend is the same in each of the longitudinal partitions 1 and 3 and the transversal partitions 2 and 4.

Preferably, each of the partitions is provided with a slot in the centre of the edge along which the partition slots are arranged for receiving additional partitions. These additional slots serve for receiving further partitions of the type of the first or fourth partition 1 or 4 for partitioning the reception area formed by the partitions. FIGS. 1b, 5 and 6 and in particular FIGS. 7 to 9 show different options of arranging additional partitions.

The partition slots should have a length that is suitable for fitting the partitions completely into each other. Preferably, each of the partition slots has a length that at least corresponds to half the length of the edge parallel to the partition slots.

The multitude of possible sizes of the reception area formed by the four partitions shown in FIGS. 13 to 16 is illustrated in FIG. 3a. By the use of further partitions for partitioning the reception area, the reception area according to FIGS. 7 to 9 is cut into halves or quarters in the longitudinal or transversal direction. If, for example, the partitions shown in FIGS. 13 to 16 are used, more than 400 different formats may be obtained. If additional partitions are used for longitudinal and transversal partitioning, the number of different possibilities doubles or quadruples. Thus a great multitude of differently sized plate-shaped goods can safely be packaged with the same packaging set.

The height of the cover is adapted to the side lengths of the partitions parallel to the direction in which the slots extend. The size of the reception area is variable as a function of the partition arrangement without any change to the size of the bottom plate and the cover. The spaces between the reception area and the cover serve as a shock absorber. The sizes of these outer areas vary as a function of the size selected for the reception area. These areas serve as shock absorbers so that there is no need of any additional padding or filling material.

The packaging set is assembled beginning with the setup of the longitudinal partition 1 whereupon the partitions 2 to 4 are either inserted clockwise as shown in FIG. 1a or anticlockwise as shown in FIG. 4. The lengths of the longitudinal and transversal partitions correspond to the longitudinal and transversal side lengths of the bottom plate. The partitions 2 to 4 are consecutively inserted into the desired slots from the top.

If the stack of plate-shaped goods is provided on the bottom plate already before the assembly of the partitions, the partitions are arranged around the stack. The stack does not have to be centrally arranged on the bottom plate. Since the frame of slotted interleavable partitions is consecutively arranged around the stack, it is sufficient if the stack is arranged parallel to the bottom plate. As evident from FIG. 10, the stack is easily accessible from any side during the assembly depending on the order in which the partitions are arranged.

If additional partitions for partitioning the reception area are provided, they may be inserted from the top upon the complete assembly of the frame. To this end, there has to be enough space between the variety of joints arranged on the bottom plate, which space corresponds to the thickness of the partitions. In order to facilitate the packaging of small plate-shaped goods, the assembly can be started with the partitions for partitioning the reception area. This is shown in FIG. 6. To this end, the partitions 1 and 4 are arranged crosswise on the bottom plate, the slotted sections pointing to the top. The plate-shaped goods are then arranged along the edges of the cross thus formed, whereupon the partitions 1 to 4 are assembled around the stack of plate-shaped goods. In contrast to the aforementioned method, however, the order in which the partitions are inserted is reversed, i.e. starting with partition 4. Moreover, the partitions are inserted upside down, i.e. the bottom surface showing to the top.

The packaging set may be completely assembled by one person in less than two minutes. Any further assistance is unnecessary since the packaging set or the frame formed of the partitions does not have to be lifted at any time during the complete assembly.

Padding or filling material is not required since the interleavable frame tightly encloses the plate-shaped goods and the outer ends of the partitions are fixated at a distance to the side walls of the cover so as to protect against shocks and shifting. Since the partitions support the cover also to the top, a static stabilisation is achieved also in this direction. Thus, as soon as the cover is assembled and the complete packaging set is fixed to the pallet, the internal frame structure is fixated and protects the packaged goods against shifting and shocks.

The packaging set of the present invention may prove useful wherever a multitude of sensitive plate-shaped goods of different sizes, such as offset printing plates, has to be shipped without excessive expenditure of material, the packaging process has to be automated and/or simplified and standard pallets are used to facilitate transport.

1-11. (canceled)

12. A packaging structure, comprising a first, a second, a third and a fourth partition, wherein each partition is provided with two opposite edges and at least two partition slots,
wherein the at least two partition slots of the first partition are arranged along one of the two opposite edges and extend essentially perpendicular to the one edge;
wherein the at least two partition slots of the second partition are arranged along the two opposite edges such that the partition slots along one edge are diagonally opposite the partition slots along the other edge and extend essentially perpendicular to the edges;
wherein the at least two partition slots of the third partition along the two opposite edges are arranged such that the partition slots along one edge are diagonally opposite the partition slots along the other edge and extend essentially perpendicular to the edges;
wherein the at least two partition slots of the fourth partition are arranged along one of the two opposite edges and extend essentially perpendicular to the one edge; and
wherein the first partition comprising at least two partition slots is connectable to a partition slot in an edge of the second partition, the second partition comprising a diagonal partition slot in the other edge is connectable to a partition slot in an edge of the third partition, the third partition comprising a diagonal partition slot in the other edge is connectable to a partition slot in an edge of the fourth partition, and the fourth partition comprising another partition slot in the edge of the fourth partition is connectable to another partition slot in the first partition.

13. The packaging structure according to claim 12, wherein the packaging structure moreover comprises a bottom plate and a cover.

14. The packaging structure according to claim 12, wherein the partitions are rectangular and the edges perpendicular to the partitions of the first and third partitions have the same length and the edges perpendicular to the partition slots of the second and fourth partitions have the same length.

15. The packaging structure according to claim 12, wherein the edges of the partitions in the direction of the partition slots have the same length.

16. The packaging structure according to claim 12, wherein the first and the third partition are each provided with the same number of partition slots and wherein the second and the fourth partition each have the same number of partition slots.

17. The packaging structure according to claim 13, wherein the edges perpendicular to the slots of the first and third partitions have the same length as the side length of the bottom plate in the longitudinal direction and the edges perpendicular to the slots of the second and fourth partitions have the same length as the side length of the bottom plate in the transversal direction.

18. The packaging structure according to claim 13, wherein the length of the edges parallel to the direction of the slots of the first to fourth partitions corresponds to the height of the cover.

19. The packaging structure according to claim 12, wherein each of the partitions is additionally provided with a central slot arranged in the center of one of the opposite edges and extends essentially perpendicular to the edge.

20. The packaging structure according to claim 19, wherein the packaging structure is moreover provided with a fifth or sixth partition, wherein the fifth partition has the same features as the first partition and the sixth partition has the same features as the fourth partition.

21. A packaging method preferably for packing plate-shaped goods comprising the steps of:
a) providing a packaging structure comprising a first, a second, a third and a fourth partition, wherein each partition is provided with two opposite edges, and at least two partition slots,
wherein the at least two partition slots of the first partition are arranged along one of the two opposite edges and extend essentially perpendicular to the one edge;
wherein the at least two partition slots of the second partition are arranged along the two opposite edges such that the partition slots along one edge are diagonally opposite the partition slots along the other edge and extend essentially perpendicular to the edges;
wherein the at least two partition slots of the third partition along the two opposite edges are arranged such that the partition slots along one edge are diagonally opposite the partition slots along the other edge and extend essentially perpendicular to the edges;
wherein the at least two partition slots of the fourth partition are arranged along one of the two opposite edges and extend essentially perpendicular to the one edge; and
wherein the first partition comprising at least two partition slots is connectable to a partition slot in an edge of the second partition, the second partition comprising a diagonal partition slot in the other edge is connectable to a partition slot in an edge of the third partition, the third partition comprising a diagonal partition slot in the other edge is connectable to a partition slot in an edge of the fourth partition, and the fourth partition comprising another partition slot in the edge of the fourth partition is connectable to another partition slot in the first partition;
b) inserting a partition slot provided in an edge of the second partition into a partition slot provided in the edge of the first partition;
c) inserting a partition slot provided in an edge of the third partition into a partition slot provided in the other edge of the second partition;
d) inserting a partition slot provided in the edge of the fourth partition into a partition slot provided in the other edge of the third partition; and
e) simultaneously inserting a further partition slot provided in the edge of the fourth partition into a further partition slot provided in the edge of the first partition.

22. The method according to claim 21, wherein in step a) a fifth or a sixth partition is provided, wherein the method further comprises the steps of:
f) simultaneously inserting a partition slot provided in an edge of the fifth partition into the central slot provided in the second partition and a further partition slot provided in the fifth partition into the central slot provided in the fourth partition; or
g) simultaneously inserting a partition slot provided in the sixth partition into the central slot provided in the first partition and a further partition slot provided in the edge of the sixth partition into the central slot of the third partition.

23. The method of claim 22, wherein in steps (f) and (g) both the fifth and sixth partitions are inserted into slots in the second and fourth partitions and in the first and third partitions, respectively.
